(19) United States
(12) Patent Application Publication
(10) Pub. No.: US 2025/0313106 A1
(43) Pub. Date: Oct. 9, 2025

(54) ION EXCHANGE FILTER

(71) Applicant: MANN+HUMMEL GmbH, Ludwigsburg (DE)

(72) Inventors: Haitao GU, Nantong city (CN); Ruihua Terry WANG, Wuxi City (CN)

(21) Appl. No.: 19/043,519

(22) Filed: Feb. 2, 2025

Related U.S. Application Data
(63) Continuation of application No. PCT/CN2024/086326, filed on Apr. 7, 2024.

(51) Int. Cl. B60L 53/302; B01D 15/10; B01D 15/36; B60L 53/31; H02J 7/00

(52) U.S. Cl. CPC B60L 53/302; B01D 15/10; B01D 15/361; B60L 53/31; H02J 7/0042

(57) ABSTRACT

An ion exchange filter includes an outer housing comprising a coolant inlet and a coolant outlet, and an ion exchanging device configured to be disposed in the outer housing. The ion exchanging device comprises an inner housing configured to be inserted into the outer housing, the ion exchange filter further comprising an inlet chamber being defined between a bottom portion of the inner housing and a bottom portion of the outer housing, an ion exchanging element disposed in the inner housing and configured to adsorb conductive ions in a coolant liquid, and an upper cover removably connecting with the inner housing and removably connecting with the outer housing, the ion exchange filter further comprising an outlet chamber defined between a top portion of the inner housing and the ion exchanging element.

### CROSS-REFERENCE TO RELATED APPLICATION

This application is a continuation application of International Application No. PCT/CN2024/086326 filed on Apr. 7, 2024, the entire disclosure of which is incorporated herein by reference for all purposes.

### BACKGROUND

Embodiments relate to an ion exchange filter, in particular for a charging pile and a charging station for charging an electric vehicle.

With fast development of electric vehicles, increasing amount of charging piles are in demand. Charging piles can be fixed on the ground or wall and installed in public buildings, residential parking lots or public charging stations. They can be used to charge various types of electric cars according to different voltage levels. Charging piles generally provide two charging modes: regular charging or slow charging, and fast charging or super charging. Super charging piles only takes about 15˜20 minutes to charge more than half of the electricity for electric vehicles.

In general, the higher a power of the charging pile, the faster the charging rate. For super charging piles, traditional air-cooled and indirect liquid cooling technologies are unable to meet the heat dissipation requirements, and immersion liquid cooling technology has become widely used. In immersion liquid cooling technology: a charging cable are disposed in a cooling pipe filled with coolant, such that the coolant is in direct contact with the charging cable. The immersion liquid cooling technology is advantageous in that the heat conduction resistance is low, and the heat dissipation efficiency is greatly improved.

However, during use of the charging pile, the coolant liquid may contain various impurities, such as conductive ions, for example as other component (such as heat sink) of a cooling circuit may release ions into the coolant liquid, thus the electric resistance of the coolant liquid for immersion liquid cooling may increase over time, which may even cause short circuits, negatively influencing the safety of charging and service life of charging piles.

To this end, it is desirable to develop a safe super charging pile that is simple in structure, and can reliably remove conductive ions from the coolant liquid, thereby improving the safety of charging and service life of charging piles.

### SUMMARY

An object of the present disclosure is to provide an ion exchange filter that is simple in structure, and can reliably remove conductive ions from a coolant liquid, thereby improving the safety of charging and service life of charging piles.

In aspects, the ion exchange filter comprises an outer housing comprising a coolant inlet and a coolant outlet, and an ion exchanging device configured to be disposed in the outer housing. The ion exchanging device comprises an inner housing configured to be inserted into the outer housing, the ion exchange filter further comprising an inlet chamber being defined between a bottom portion of the inner housing and a bottom portion of the outer housing, an ion exchanging element disposed in the inner housing and configured to adsorb conductive ions in a coolant liquid, and an upper cover removably connecting with the inner housing and removably connecting with the outer housing, the ion exchange filter further comprising an outlet chamber defined between a top portion of the inner housing and the ion exchanging element.

The upper cover may comprise inner threads configured to engage with corresponding outer threads of the inner housing, and outer threads configured to engage with corresponding inner threads of the outer housing.

The outer threads of the inner housing may comprise at least one interrupting recess extending parallel to an axial axis of the ion exchange filter, the at least one interrupting recess being configured to provide a gas relief path when the upper cover is threaded on or threaded off the inner housing.

The ion exchanging element may be comprised of resin.

The ion exchange filter may further comprise a lower grid injection molded together with the inner housing below the ion exchanging element, the lower grid being configured to filter off particles in the coolant liquid.

The ion exchange filter may further comprise an upper grid injection molded together with the inner housing above the ion exchanging element, the upper grid being configured to filter off particles in the coolant liquid.

The ion exchange filter may further comprise an upper sealing ring disposed circumferentially between the upper cover and the outer housing, and a lower sealing ring disposed circumferentially between the bottom portion of the inner housing and the outer housing.

The ion exchange filter may further comprise a bypass passage defined between the inner housing and the outer housing and above the lower sealing ring, the bypass passage being in fluid communication with the coolant outlet. The inner housing may comprise a bypass chamber in the bottom portion of the inner housing, and a bypass opening disposed in a side wall of the inner housing. The ion exchange filter may further comprise a bypass valve disposed in the bypass chamber. The bypass chamber may be in fluid communication with the inlet chamber via the bypass valve and may be in fluid communication with the bypass passage via the bypass opening. The bypass valve may be configured to be opened when coolant pressure within the inlet chamber is greater than a threshold pressure, so that the coolant liquid flows from the inlet chamber, through the bypass chamber, the bypass opening and the bypass passage, and to the coolant outlet.

The ion exchange filter may further comprise a PH sensor disposed in the coolant liquid and configured to detect a PH value of the coolant liquid, the PH value indicating whether the resin is in a normal condition.

The charging pile may further comprise a conductivity sensor disposed in the coolant liquid and configured to detect a conductivity value of the coolant liquid, the conductivity value indicating an amount of the conductive ions in the coolant liquid.

The ion exchange filter may further comprise a split support for mounting the ion exchange filter to a charging pile, the split support may comprise inner threads configured to engage with corresponding outer threads disposed on a middle portion of the outer housing.

The ion exchange filter according to embodiments can reliably remove the conductive ions from the coolant liquid, thereby improving the safety of charging and service life of charging piles.

In addition, the coolant liquid can be pure water, water and ethylene glycol mixture, or other cooling oil, etc., and can meet the requirements of the charging pile cooling at a low cost.

In aspects, a charging pile for an electric vehicle is provided. The charging pile includes the ion exchange filter described above, an input end connected to a power grid, an output end comprising charging plugs for charging an electric vehicle, and a charging device connected to the input end and the output end via a cable comprising the cooling passage, and configured to charge the electric vehicle using electric power from the power grid. The charging pile further includes a cooling circuit configured to provide the coolant liquid to the cooling passage disposed in the cable, and to receive heated coolant liquid from the cooling passage. The ion exchange filter is disposed in the cooling circuit and is configured to adsorb the conductive ions in the coolant liquid before the coolant liquid is provided to the cooling passage.

The charging pile may comprise a PH sensor or a conductivity sensor, which facilitates to determine whether the resin is in normal condition, thereby ensuring efficient cooling of charging piles.

Since the upper cover is in threaded connection with both the inner housing and the outer housing, the resin can easily be removed for regeneration or replace when the resin reaches the end of its service life. In addition, the upper cover, the inner housing, the sealing ring can all be replaced easily, thus is more environmentally friendly, reduces the long-term use cost, and improves the service life of the ion exchange filter.

In addition, since the upper cover is in threaded connection with both the inner housing and the outer housing, threaded connection will generate much less slags compared with welding connection, thus is more environmentally friendly, reduces the long-term use cost, and improves the service life of the ion exchange filter.

The at least one interrupting recess may provide gas relief path when the upper cover is threaded on or threaded off, so as to facilitate the mounting and demounting of the ion exchange filter.

The ion exchange filter is provided with a bypass valve, and the threshold pressure of the bypass valve is set according to system requirements. The bypass valve is advantageous for the following working conditions: (1) The temperature is extremely low in winter, viscosity of the coolant liquid is relatively high, and coolant pressure within the inlet chamber is greater than a threshold pressure, causing the bypass valve to be opened, thus the coolant liquid circulates quickly through the bypass passage, which is conducive to the rapid increase of the temperature of coolant liquid, so as to speed up the startup of the cooling system and to improve the heat dissipation efficiency; (2) When there are many impurities in the grid or other conditions that renders the grid to be blocked, coolant pressure within the inlet chamber is greater than a threshold pressure, causing the bypass valve to be opened to ensure that the coolant liquid can be circulated; (3) Other situations where the flow resistance changes greatly, such as a sharp increase in flow rate or a sharp decrease in flow rate.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings.

FIG. 1 is a schematic front view of an ion exchange filter according to embodiments.

FIG. 2 is a schematic cross-sectional view of an ion exchange filter according to embodiments.

FIG. 3 is a schematic perspective view of an inner housing equipped with a bypass valve according to embodiments.

FIG. 4 is a schematic view of an example charging pile for an electric vehicle according to embodiments.

FIG. 5 is a schematic cross-sectional view of an example cable according to embodiments.

FIG. 6 is a schematic cross-sectional view of another example cable according to embodiments.

### DETAILED DESCRIPTION

The following description is merely exemplary in nature and is not intended to limit the present disclosure, application, or uses. It should be understood that throughout the drawings, corresponding reference numerals indicate like or corresponding parts and features. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “horizontal”, “vertical”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology are used descriptively for the figures, and do not represent limitations on the scope of the disclosure, as defined by the appended claims.

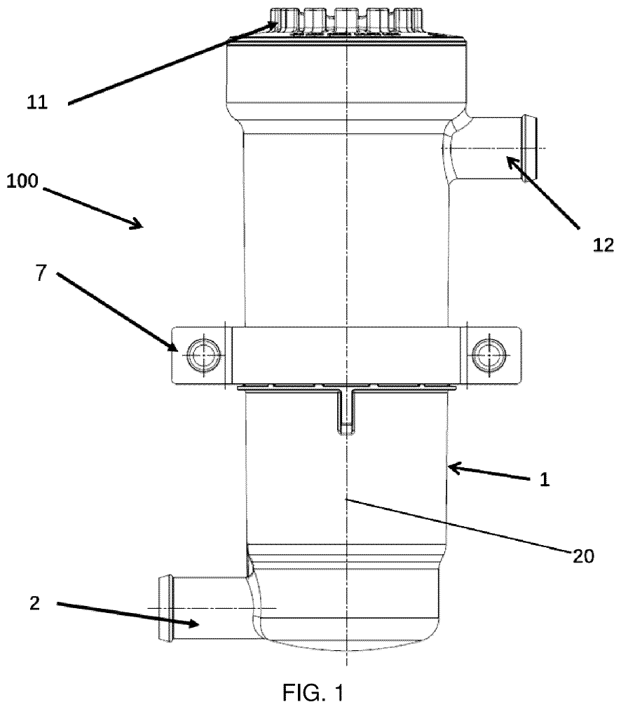

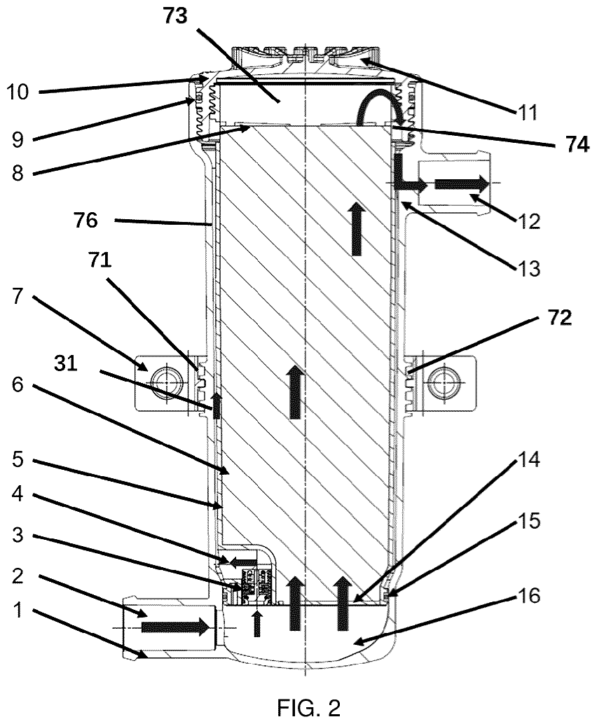

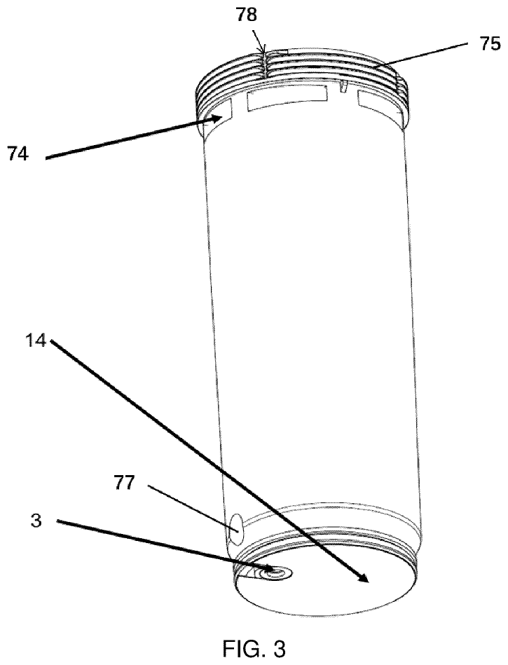

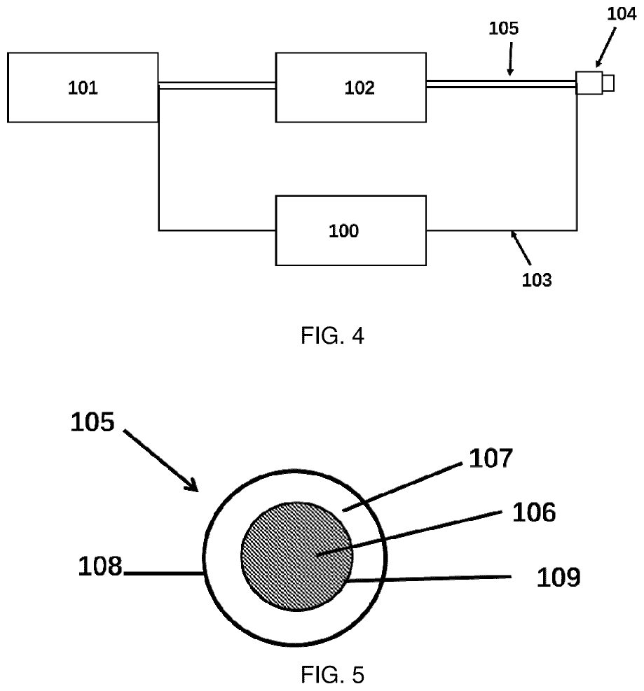

Referring now to the drawings, wherein like reference numbers refer to like features throughout the several views, FIG. 1 is a schematic front view of an ion exchange filter 100 according to embodiments. FIG. 2 is a schematic cross-sectional view of the ion exchange filter 100 according to embodiments. FIG. 3 is a schematic perspective view of an inner housing 5 equipped with a bypass valve 3 according to embodiments. FIG. 4 is a schematic view of an example charging pile for an electric vehicle according to embodiments.

According to one example, the charging pile may comprise an input end connected to a power grid 101; an output end equipped with charging plugs 104 for charging an electric vehicle; and a charging device 102. According to one example, the charging device 102 is connected to the input end and the output end via a cable 105, and configured to charge the electric vehicle using electric power from the power grid 101. According to one example, the charging device 102 may comprise power electronics for the charging pile and a transformer with rectifier for converting alternating current from the power grid 101 into direct current of desired current level.

According to one example, the charging pile may comprise a cooling circuit 103 configured to provide coolant liquid to a cooling passage 107 disposed in the cable and to receive heated coolant liquid from the cooling passage. According to one example, the coolant liquid may be pure water, which is easily and is low in cost. The coolant liquid may also be water and ethylene glycol mixture, which can meet the requirements of the charging pile cooling at a low cost. As understood by those skilled in the art, the coolant liquid can be comprised of any suitable coolant for cooling the charging pile, such as cooling oil, without departing the scope of the disclosure. According to one example, the cooling circuit 103 may comprise a pump for circulating the cooling liquid in the cooling circuit 103. The cooling circuit 103 may comprise other components as needed, such as a sensor and/or controller, etc., without departing the scope of the disclosure.

According to one example, the charging pile may comprise the ion exchange filter 100. The ion exchange filter 100 is disposed in the cooling circuit 103 and configured to adsorb conductive ions in the coolant liquid before the coolant liquid is provided to the cooling passage 107. The charging pile may comprise other components as needed, such as a sensor and/or controller, etc., without departing the scope of the disclosure. The ion exchange filter 100 according to embodiments can reliably remove conductive ions from the coolant liquid, thereby improving the safety of charging and service life of charging piles.

According to one example, the ion exchange filter 100 may comprise: an outer housing 1 comprising a coolant inlet 2 and a coolant outlet 12; and an ion exchanging device 11 disposed in the outer housing 1. According to one example, the ion exchanging device 11 may comprise: an inner housing 5 inserted into the outer housing 1 with an inlet chamber 16 defined between a bottom portion of the inner housing 5 and a bottom portion of the outer housing 1; an ion exchanging element 6 which is disposed in the inner housing 5 and configured to adsorb conductive ions in the coolant liquid; and an upper cover 10 removably connecting with the inner housing 5 and removably connecting with the outer housing 1. An outlet chamber 73 is located between the inner housing 5 and the ion exchanging element 6. The ion exchange filter 100 may comprise a split support 7 for mounting the ion exchange filter 100 to the charging pile. The ion exchanging element 6 may be comprised of resin. As understood by those skilled in the art, the ion exchanging element 6 can utilize any suitable material, without departing the scope of the disclosure.

According to one example, the split support 7 may be provided with inner threads 71 for engaging with corresponding outer threads 72 provided on a middle portion of the outer housing 1. Threaded connection facilitates the mounting of the ion exchange filter 100. As understood by those skilled in the art, the split support 7 can utilize any suitable means for mounting the ion exchange filter 100 to the charging pile, such as screw and mounting hole, without departing the scope of the disclosure.

According to one example, the upper cover 10 may be provided with inner threads for engaging with corresponding outer threads 75 of the inner housing 5 and outer threads for engaging with corresponding inner threads of the outer housing 1. As understood by those skilled in the art, the upper cover 10 can utilize any suitable means for connecting with the inner housing 5 and connecting with the outer housing 1, such as snap connection, without departing the scope of the disclosure. Since the upper cover 10 is in threaded connection with both the inner housing 5 and the outer housing 1, the resin can easily be removed for regeneration or replace when the resin reaches the end of its service life. In addition, threaded connection will generate much less slags compared with welding connection, thus is more environmentally friendly, reduces the long-term use cost, and improves the service life of the ion exchange filter 100.

According to one example, the outer threads 75 of the inner housing 5 may comprise at least one interrupting recess 78 extending parallel to an axial axis 20 of the ion exchange filter 100. The at least one interrupting recess 78 may provide gas relief path when the upper cover 10 is threaded on or threaded off, so as to facilitate the mounting and demounting of the ion exchange filter 100.

According to one example, the ion exchange filter 100 may further comprise a lower grid 14 and an upper grid 8. The lower grid 14 may be injection molded together with the inner housing 5 below the ion exchanging element 6 and is configured to filter off particles in the coolant liquid. The upper grid 8 may be injection molded together with the inner housing 5 above the ion exchanging element 6 and is configured to filter off particles in the coolant liquid. As understood by those skilled in the art, the lower grid 14 and the upper grid 8 can be made separately and are mounted to the inner housing 5 by suitable means, without departing the scope of the disclosure.

According to one example, the ion exchange filter 100 may further comprise: an upper sealing ring 9 disposed circumferentially between the upper cover 10 and the outer housing 1; and/or a lower sealing ring 15 disposed circumferentially between the bottom portion of the inner housing 5 and the outer housing 1.

According to one example, a bypass passage 76 may be defined between the inner housing 5 and the outer housing 1 above the lower sealing ring 15 and is in fluid communication with the coolant outlet 12. The inner housing 5 may comprise a bypass chamber 4 in the bottom portion and a bypass opening 77 disposed in side wall of the inner housing 5. The ion exchange filter 100 further comprises a bypass valve 3 disposed in the bypass chamber 4. The bypass chamber 4 is in fluid communication with the inlet chamber 16 via the bypass valve 3 and is in fluid communication with the bypass passage 76 via the bypass opening 77.

The bypass valve 3 is configured to be opened when coolant pressure within the inlet chamber 16 is greater than a threshold pressure, so as to communicate the coolant liquid through the bypass chamber 4 from the inlet chamber 16, through the bypass passage 76, and to the coolant outlet 12, as shown by relative thin arrow 31.

The threshold pressure of the bypass valve 3 is set according to system requirements. The bypass valve 3 is advantageous for the following working conditions: (1) The temperature is extremely low in winter, viscosity of the coolant liquid is relatively high, and coolant pressure within the inlet chamber 16 is greater than the threshold pressure, causing the bypass valve 3 to be opened, thus the coolant liquid circulates quickly through the bypass passage 76, which is conducive to the rapid increase of the temperature of coolant liquid, so as to speed up the startup of the cooling system and to improve the heat dissipation efficiency; (2) When there are many impurities in the grid or other conditions that renders the grid to be blocked, coolant pressure within the inlet chamber 16 is greater than a threshold pressure, causing the bypass valve 3 to be opened to ensure that the coolant liquid can be circulated; (3) Other situations where the flow resistance changes greatly, such as a sharp increase in flow rate or a sharp decrease in flow rate.

According to one example, the ion exchange filter 100 may comprise a PH sensor and/or a conductivity sensor disposed in the coolant liquid. The PH sensor is configured to detect PH value of the coolant liquid, the PH value indicates whether the resin is in normal condition. The conductivity sensor is configured to detect conductivity value of the coolant liquid, the conductivity value indicates amount of the conductive ions in the coolant liquid. The ion exchange filter 100 may comprise a controller configured to notice the user or automatically control the charging pile when the PH sensor and/or the conductivity sensor indicate abnormal conditions. For example, if the reading of the PH sensor is between 6.5 and 7.5, the controller will take no actions. If the reading of the PH sensor is below 6.5 or above 7.5 the controller will notice the user or automatically control the charging pile, for example, stop charging to the electric vehicles. As understood by those skilled in the art, any other suitable PH values may be used, without departing the scope of the disclosure.

Operation of the ion exchange filter 100 will be described now. The coolant liquid enters the ion exchange filter 100 via the coolant inlet 2, flows through the lower grid 14, the ion exchanging element 6, and the upper grid 8, then flows into the outlet chamber 73, and finally flows out of the coolant outlet 12 via an opening 74 in the upper portion of the side wall of the inner housing 5, as shown by relative thick arrow 13. The coolant liquid exiting the coolant outlet 12 will be directed to the cooling passage 107. In this regard, the particles entrained in the coolant liquid will be filtered out by the lower grid 14 and the upper grid 8, and the conductive ions in the coolant liquid will be absorbed by the ion exchanging element 6, thereby improving the safety of charging and service life of charging piles.

The bypass valve 3 will be opened when coolant pressure within the inlet chamber 16 is greater than a threshold pressure, so as to communicate the coolant liquid through the bypass chamber 4 from the inlet chamber 16, through the bypass passage 76, and to the coolant outlet 12, as shown by relative thin arrow 31. The bypass valve 3 is advantageous for the following working conditions: (1) The temperature is extremely low in winter, viscosity of the coolant liquid is relatively high, and coolant pressure within the inlet chamber 16 is greater than the threshold pressure, causing the bypass valve 3 to be opened, thus the coolant liquid circulates quickly through the bypass passage 76, which is conducive to the rapid increase of the temperature of coolant liquid, so as to speed up the startup of the cooling system and to improve the heat dissipation efficiency; (2) When there are many impurities in the grid or other conditions that renders the grid to be blocked, coolant pressure within the inlet chamber 16 is greater than a threshold pressure, causing the bypass valve 3 to be opened to ensure that the coolant liquid can be circulated; (3) Other situations where the flow resistance changes greatly, such as a sharp increase in flow rate or a sharp decrease in flow rate.

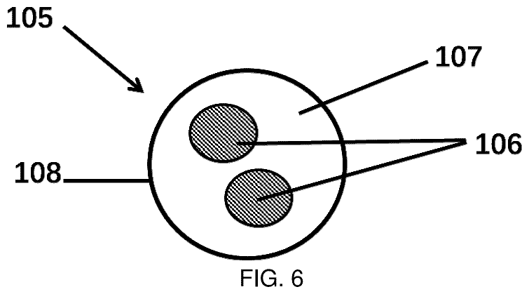

FIG. 5 is a schematic cross-sectional view of an example cable 105 according to embodiments. FIG. 6 is a schematic cross-sectional view of another example cable 105 according to embodiments. As shown in FIG. 5, the cable 105 may comprise an outer sheath 108, a wire 106 with an outer shield 109, and a cooling passage 107 defined between the outer sheath 108 and the wire 106. As shown in FIG. 6, the cable 105 may comprise an outer sheath 108, two wires 106 with respective outer shield 109, and a cooling passage 107 defined between the outer sheath 108 and the two wires 106. As understood by those skilled in the art, cable 105 may comprise any other suitable number of wires 106, without departing the scope of the disclosure. As understood by those skilled in the art, cable 105 may comprise any other components, such as communicate lines, without departing the scope of the disclosure.

In addition, the upper cover 10, the inner housing 5, the sealing rings 9, 15 can all be replaced easily, thus is more environmentally friendly, reduces the long-term use cost, and improves the service life of the ion exchange filter 100.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. An ion exchange filter comprising:
an outer housing comprising a coolant inlet and a coolant outlet; and
an ion exchanging device configured to be disposed in the outer housing, the ion exchanging device comprising:
an inner housing configured to be inserted into the outer housing, the ion exchange filter further comprising an inlet chamber being defined between a bottom portion of the inner housing and a bottom portion of the outer housing;
an ion exchanging element disposed in the inner housing and configured to adsorb conductive ions in a coolant liquid; and
an upper cover removably connecting with the inner housing and removably connecting with the outer housing, the ion exchange filter further comprising an outlet chamber defined between a top portion of the inner housing and the ion exchanging element,
wherein the upper cover comprises:
inner threads configured to engage with corresponding outer threads of the inner housing; and
outer threads configured to engage with corresponding inner threads of the outer housing.

2. The ion exchange filter according to claim 1, wherein the outer threads of the inner housing comprise at least one interrupting recess extending parallel to an axial axis of the ion exchange filter, the at least one interrupting recess being configured to provide a gas relief path when the upper cover is threaded on or threaded off the inner housing.

3. The ion exchange filter according to claim 1, wherein the ion exchanging element is comprised of resin.

4. The ion exchange filter according to claim 1, wherein the ion exchanging device further comprises a lower grid injection molded together with the inner housing below the ion exchanging element, the lower grid being configured to filter off particles in the coolant liquid.

5. The ion exchange filter according to claim 4, wherein the ion exchanging device further comprises an upper grid injection molded together with the inner housing above the ion exchanging element, the upper grid being configured to filter off particles in the coolant liquid.

6. The ion exchange filter according to claim 1, further comprising:
an upper sealing ring disposed circumferentially between the upper cover and the outer housing; and
a lower sealing ring disposed circumferentially between the bottom portion of the inner housing and the outer housing.

7. The ion exchange filter according to claim 6, further comprising a bypass passage defined between the inner housing and the outer housing and above the lower sealing ring, the bypass passage being in fluid communication with the coolant outlet,
wherein the inner housing comprises a bypass chamber in the bottom portion of the inner housing, and a bypass opening disposed in a side wall of the inner housing,
wherein the ion exchange filter further comprises a bypass valve disposed in the bypass chamber,
wherein the bypass chamber is in fluid communication with the inlet chamber via the bypass valve and is in fluid communication with the bypass passage via the bypass opening, and
wherein the bypass valve is configured to be opened when coolant pressure within the inlet chamber is greater than a threshold pressure, so that the coolant liquid flows from the inlet chamber, through the bypass chamber, the bypass opening and the bypass passage, and to the coolant outlet.

8. The ion exchange filter according to claim 3, further comprising a PH sensor disposed in the coolant liquid and configured to detect a PH value of the coolant liquid, the PH value indicating whether the resin is in a normal condition.

9. The ion exchange filter according to claim 1, further comprising a conductivity sensor disposed in the coolant liquid and configured to detect a conductivity value of the coolant liquid, the conductivity value indicating an amount of the conductive ions in the coolant liquid.

10. The ion exchange filter according to claim 1, further comprising a split support for mounting the ion exchange filter to a charging pile, the split support comprising inner threads configured to engage with corresponding outer threads disposed on a middle portion of the outer housing.

11. A charging pile for an electric vehicle, the charging pile comprising:
an ion exchange filter comprising:
an outer housing comprising a coolant inlet and a coolant outlet; and
an ion exchanging device configured to be disposed in the outer housing, the ion exchanging device comprising:
an inner housing configured to be inserted into the outer housing, the ion exchange filter further comprising an inlet chamber being defined between a bottom portion of the inner housing and a bottom portion of the outer housing;
an ion exchanging element disposed in the inner housing and configured to adsorb conductive ions in a coolant liquid; and
an upper cover removably connecting with the inner housing and removably connecting with the outer housing, the ion exchange filter further comprising an outlet chamber defined between a top portion of the inner housing and the ion exchanging element,
wherein the upper cover comprises:
inner threads configured to engage with corresponding outer threads of the inner housing; and
outer threads configured to engage with corresponding inner threads of the outer housing;
an input end connected to a power grid;
an output end comprising charging plugs for charging an electric vehicle;
a charging device connected to the input end and the output end via a cable comprising a cooling passage, and configured to charge the electric vehicle using electric power from the power grid; and
a cooling circuit configured to provide the coolant liquid to the cooling passage disposed in the cable, and to receive heated coolant liquid from the cooling passage,
wherein the ion exchange filter is disposed in the cooling circuit and is configured to adsorb the conductive ions in the coolant liquid before the coolant liquid is provided to the cooling passage.
